(19) United States
(12) Patent Application Publication
(10) Pub. No.: US 2005/0210298 A1
(43) Pub. Date: Sep. 22, 2005

(54) Method for controlling a plurality of units networked to give a network, and network comprising a plurality of networked units

(76) Inventor: Harald Schoepp, Ettlingen (DE)

Correspondence Address: Partick J O'Shea;Gauthier & Connors, Suite 3300, 225 Franklin Street, Boston, MA, 02110, US

(21) Appl. No.: 10/493,723

(22) PCT Filed: Oct. 25, 2002
(86) PCT No.: PCT/EP02/11956

§ 371 Date: Dec. 15, 2004

(30) Foreign Application Priority Data
Oct. 26, 2001 (DE) 101 52 324.6

(51) Int. Cl. G06F 1/26; G06F 15/16

(52) U.S. Cl. 713/300; 709/253; 340/310.01

(57) ABSTRACT

In a network, for example, a ring-type MOST network installed in a vehicle, a plurality of units— a master unit (M) as well as a plurality of slave units oo (S)— are networked, preferably through an optical data bus (D), and connected through supply lines (L) to a central voltage source such as the on-board battery of the et) vehicle. In order to enhance the operational reliability, error diagnostics, and overall performance of the network, data are also transmitted through the supply lines (L)—for example, diagnostic data for error diagnostics or update data to update the individual units (M, S). The invention is especially suited for use in a motor vehicle.

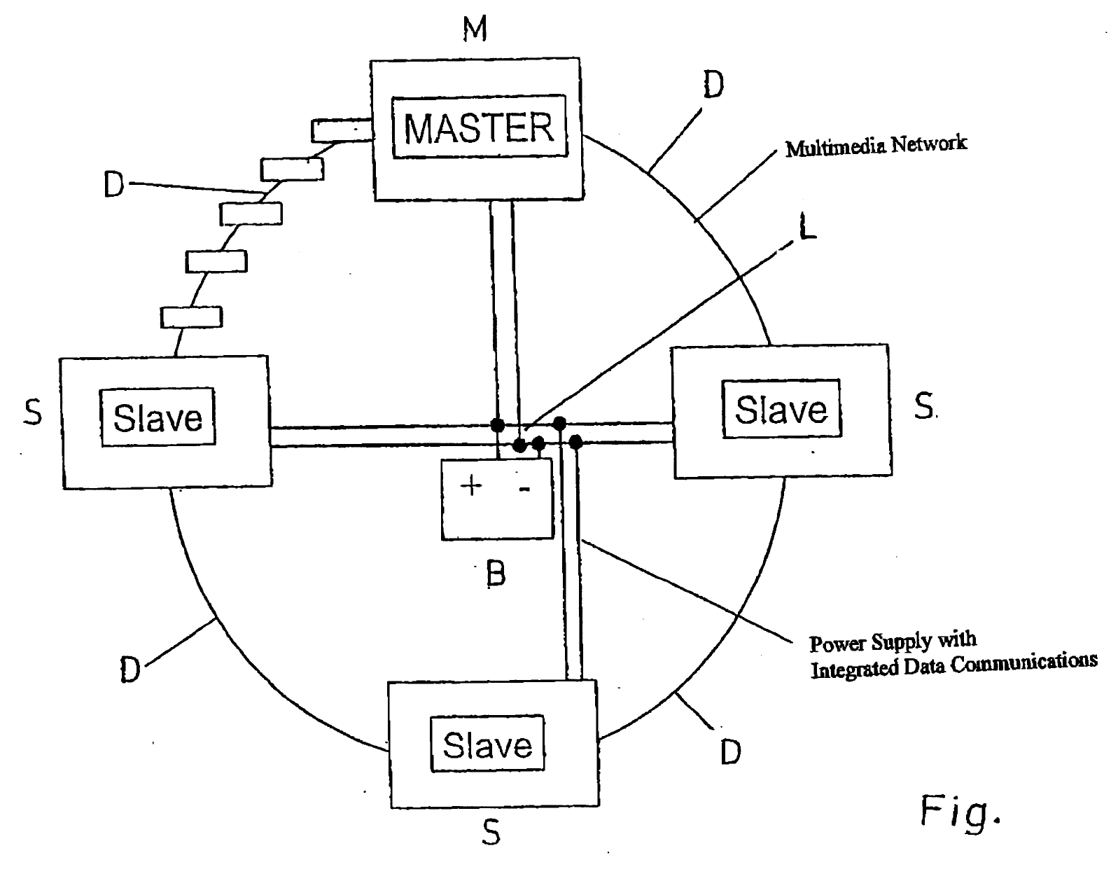

The invention relates to a method for controlling a plurality of units networked through a data bus to create a network.

The invention additionally relates to a network comprising a plurality of units networked through a data bus.

A variety of networking concepts exists for installation in motor vehicles, which link distributed system functions of multimedia systems, for example, the so-called MOST network which networks a plurality of units such as a radio receiver, CD player, DVD player, cassette player, navigation device, mobile telephone, television receiver, display screen, audio system—to name only a few examples—through an electrical or optical data bus.

MOST, the acronym that stands for Media Oriented System Transport, or Media Oriented Synchronous Transfer, is the designation both for a multimedia network and a standard developed specifically for application in motor vehicles, but not restricted to this area of application.

Although MOST networks operate in a consistent and reliable fashion, it is nevertheless desirable to enhance their operational reliability.

The goal of the invention is therefore to enhance the performance, specifically, the operational reliability and error diagnostics, of a network comprising a plurality of units networked together.

In terms of a method, this goal is achieved by the features indicated in claim 1, whereby the units are connected through the supply lines to a central voltage source, and whereby the supply lines are also used to transmit data.

In terms of a device, this goal is achieved by the features indicated in claim 13, whereby the units are connected through supply lines to a central voltage source, and whereby the supply lines may also be used to transmit data.

With the procedure according to the invention using the supply lines both for the voltage supply and for the transmission of data, the operational reliability of the network according to the invention is significantly enhanced.

In one embodiment of the invention, the supply lines are utilized for data transmission whenever errors in the transmission of data occur on the data bus. In the event errors occur, diagnostic data for error diagnostics are transmitted to the individual units.

In another embodiment, which is preferably combined with the previous embodiment, data for an update are sent to the individual units of the network through the supply lines.

In yet another embodiment of the invention, the units networked to each other within the network are controlled through the supply lines.

For example, it is possible to connect the network through the supply lines to a second network.

A coaxial cable or an optical cable, for example, may be provided for the data bus.

The data rate selected for the supply lines is, for example, lower than on the data bus.

An especially advantageous approach is to design the central voltage source as an intelligent control unit which itself actively participates in data communications through the supply lines. For example information is transmitted to the units of the network about the status of the vehicle electrical distribution system. It is possible to implement a so-called intelligent power management that controls the load of the vehicle electrical distribution system.

In the network according to the invention, preferably, a master unit and a plurality of slave units are networked.

The network may, for example, be in the form of a MOST network, a D2B network, or an IEEE1394 network.

The following discussion explains the invention in more detail based on the figure.

In the figure, a plurality of units—a master unit M and a plurality of slave units—are networked through an optical data bus D. The network is, for example, in the form of a MOST network and is installed in a motor vehicle. Master unit M and slave units S are connected through supply lines L to the car battery B. Since all the M and S units are connected to a central voltage source, the car battery, they are also networked completely relative to each other through supply lines L. The supply line system thus represents a second network through which data can be transferred both to and between the individual M and S units.

As was already mentioned, the network of supply lines can be utilized for the transmission of data only in the event of errors on the data bus. However, it is also possible to utilize it as well for the transmission of update data to update individual M and S units. In addition, the network comprising connection lines L can also be connected to another network. The data rate selected for the supply lines is, for example, lower than on the data bus. The central voltage source is preferably in the form of an intelligent control unit which is integrated into the data communications through the supply lines, with the result, for example, that information about the status of the electrical distribution system of the vehicle can be transmitted to the individual units linked in the network. By implementing power management, as it is known, it is possible to control the load of the vehicle electrical distribution system.

The method according to the invention and network according to the invention are especially suitable for application in a motor vehicle since the supply line network is already available in any case, and for this reason, there is no need to install additional copper wiring.

### List of Reference Notations

B battery
D data bus
L supply line
M master unit
S slave unit

1. A Mmethod for controlling a plurality of units networked through a data bus to create a network, comprising:
providing power to the units through supply lines, wherein the units are connected through the supply lines to a central voltage source, and that the supply lines rare also utilized for the transmission of data.

2. The method of claim 1, wherein the network is configured and arranged as a ring-shaped network.

3. The method of claim 1, wherein data are transmitted through the supply lines only in the event thaterrors occur during the transmission of data on the data bus.

4. The method of claim 3, wherein diagnostic data to implement error diagnostics are transmitted through the supply lines.

5. The method of claim 1, wherein data for an update are transmitted to the individual units of the network through the supply lines.

6. The method of claim 1, comprising controlling the units through the supply lines.

7. The method of claim 1, wherein the supply lines of the network are provided to implement a connection to another network.

8. The method of claim 1, wherein an optical bus is provided as the data bus.

9. The method of claim 1, wherein the network comprises a master unit and a plurality of slave units are networked.

10. The method of claim 1, wherein a MOST network, a D2B network, or an IEEE1394 network is provided as the network.

11 . The method of claim 1, wherein the network is configured and arranged for installation in a vehicle.

12. The mnethod of claim 11, wherein an on-board battery is provided as the central voltage source for the units.

13. The method of claim 1, wherein the central voltage source is implemented as an intelligent control unit that participates in data communications through the supply lines.

14. The method of claim 12, wherein the load of the central voltage source is controlled.

15. A network comprising a plurality of units networked through a data bus, wherein the units are connected through supply lines to a central voltage source, and that the supply lines can also be used to transmit data.

16. The network of claim 15, wherein the network is configured and arranged as a ring-shaped network.

17. The network of claim 15. wherein data can be transmitted through the supply lines only when errors occur during the transmission of data on the data bus.

18. The method of claim 17, wherein diagnostic data to implement error diagnostics can be transmitted through the supply lines.

19. The network of claim 15, wherein data for an update can be transmitted to the individual units of the network through the supply lines.

20. The network of claim 16, wherein the units can be controlled through the supply lines.

21. The network of claim 20, wherein the network can be connected through the supply lines to another network.

22. The network of claim 21, wherein the data bus (D) comprises an optical bus.

23. The network of claim 22, wherein the network comprises a master unit and a plurality of slave units that are networked.

24. The network of claim 23, wherein the network is configured and arranged as a MOST network, a D2B network, or an IEEE 1394 network.

25. The network of claim 24, wherein the network is provided for installation in a vehicle.

26. The network of claim 25, wherein the central voltage source comprises an on-board battery (B) of the vehicle.

27. The network of claim 26, wherein the central voltage source comprises an intelligent control unit that is connected through the supply lines to the data communications system.

28. The network of claim 27, wherein the load of the central voltage source is controllable.

29. The network of claim 28, wherein the data rate selected on the supply lines is lower than on the data bus.
